(19) United States
(12) Patent Application Publication
(10) Pub. No.: US 2013/0324031 A1
(43) Pub. Date: Dec. 5, 2013

(54) DYNAMIC ALLOCATION OF AUDIO CHANNEL FOR SURROUND SOUND SYSTEMS

(71) Applicant: Alexandre Jose Figueiredo Loureiro, Brasilia (BR)

(72) Inventor: Alexandre Jose Figueiredo Loureiro, Brasilia (BR)

(73) Assignee: NOKIA CORPORATION, Espoo (FI)

(21) Appl. No.: 13/485,621

(22) Filed: May 31, 2012

(51) Int. Cl. H04H 40/00

(52) U.S. Cl. 455/3.06

(57) ABSTRACT

A method, apparatus, and computer program product that performs dynamic allocation of audio channels to wireless devices, including wireless audio speakers and wireless mobile terminals. The wireless speaker or mobile terminal establishes a communications link with the amplifier/controller of a multiple channel media system, such as a home theatre. The wireless speakers/mobile terminals contain an algorithm that performs location determination relative to the controller and transmission of the location information to the controller. The controller calculates the position of the wireless speaker in relation to the ideal location of each channel of a multi-channel audio system and allocates channel selection to each of the wireless speakers/mobile terminals. The communications link may be established over WiFi, wireless telephone network, or other wireless method.

### TECHNOLOGICAL FIELD

An embodiment of the present invention is related to the field of wireless audio speaker systems, namely the allocation of audio channels in surround sound systems using wireless devices.

### BACKGROUND

Typical surround sound systems for home theatre or other purposes incorporate at least five channels: front right and left channels, rear right and left channels and a front center channel. In a wireless audio system, the amplifier broadcasts the audio channels over radio frequencies. The speakers have to “select” one of the frequencies to receive so that the proper sound channel can be received and reproduced by the correct speaker. Normally the selection of which channel to play through each speaker is performed manually. However, the manual selection may not always be optimized and may not respond dynamically to changing conditions.

### BRIEF SUMMARY

A method is provided that comprises establishing a wireless communications link in a mobile speaker device to a multiple channel media system controller; causing transmission of location information of the mobile speaker device to the system controller; receiving an audio channel allocation from the system controller; and selecting the allocated audio channel in the mobile speaker device. The method of one embodiment further comprises determining the location of the mobile speaker device, and locating a mobile wireless speaker device within the operating area of a wireless multiple channel audio system. Some features of example embodiments of the method include: the wireless communications link is one of a WiFi, mobile telephone network connection or any other wireless link, location is determined by any positioning system transceiver (such as, global positioning system (GPS) transceiver), mobile telephone network location system or WiFi location based system. The channel allocation can comprise a plurality of overlapping channels, the mobile speaker device is an audio system speaker, or the mobile speaker device is a mobile telephone device.

An alternative embodiment is an apparatus comprising at least a processor, a memory, and computer instructions stored in memory which, when executed by the processor, cause the apparatus to: establish a wireless communications link in a mobile speaker device to a multiple channel media system controller, cause transmission of location information of a mobile speaker device to the system controller, receive an audio channel allocation from the system controller, and select the allocated audio channel in the mobile speaker device. The apparatus of one embodiment may also comprise computer instructions in memory which, when executed by the processor, cause the apparatus to determine the location of the mobile speaker device. Other characteristics of example embodiments of the apparatus include: the wireless communications link is one of a WiFi or mobile telephone network connection, location is determined by a global positioning system transceiver, the channel allocation may comprise a plurality of overlapping channels, the mobile speaker device may be an audio system speaker, or the mobile speaker device is a mobile telephone device.

Another embodiment is a computer program product comprising computer program instructions stored in a non-transitory computer readable medium, said instructions when executed with a processor cause an apparatus to perform: establishing a wireless communications link in a mobile speaker device to a multiple channel media system controller, causing transmission of location information of a mobile speaker device to the system controller, receiving an audio channel allocation from the system controller; and selecting the allocated audio channel in the mobile speaker device. The computer program product of one embodiment may further comprise instructions that, when executed with a processor, cause an apparatus to perform determining the location of the mobile speaker device. Other features of the computer program product of example embodiments are the channel allocation comprises a plurality of overlapping channels, and the wireless communications link is one of a WiFi or mobile telephone network connection.

In a further embodiment, an apparatus may be provided comprising a means, such as a processor and a communications interface, for establishing a wireless communications link in a mobile speaker device to a multiple channel media system controller; a means for causing transmission of location information of a mobile speaker device to the system controller; a means for receiving an audio channel allocation from the system controller; and a means, such as a processor and a memory, for selecting the allocated audio channel in the mobile speaker device.

### BRIEF DESCRIPTION OF THE DRAWING(S)

Having thus described embodiments of the invention in general terms, reference will now be made to the accompanying drawings, which are not necessarily drawn to scale, and wherein:

FIG. 1 is a schematic diagram of an apparatus that may be embodied as a mobile wireless terminal, and that may be specifically configured in accordance with an example embodiment of the invention;

FIG. 2 is a schematic diagram of a surround sound system that may be configured in accordance with an example embodiment of the invention;

FIG. 3 is a schematic diagram of a mobile terminal interface to a surround system controller in accordance with one embodiment of the invention; and

FIG. 4 is a schematic diagram of a mobile terminal located in overlapping audio regions in accordance with one embodiment of the invention.

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

As used in this application, the term “circuitry” refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of “circuitry” applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or application specific integrated circuit for a mobile phone or a similar integrated circuit in server, a cellular network device, or other network device.

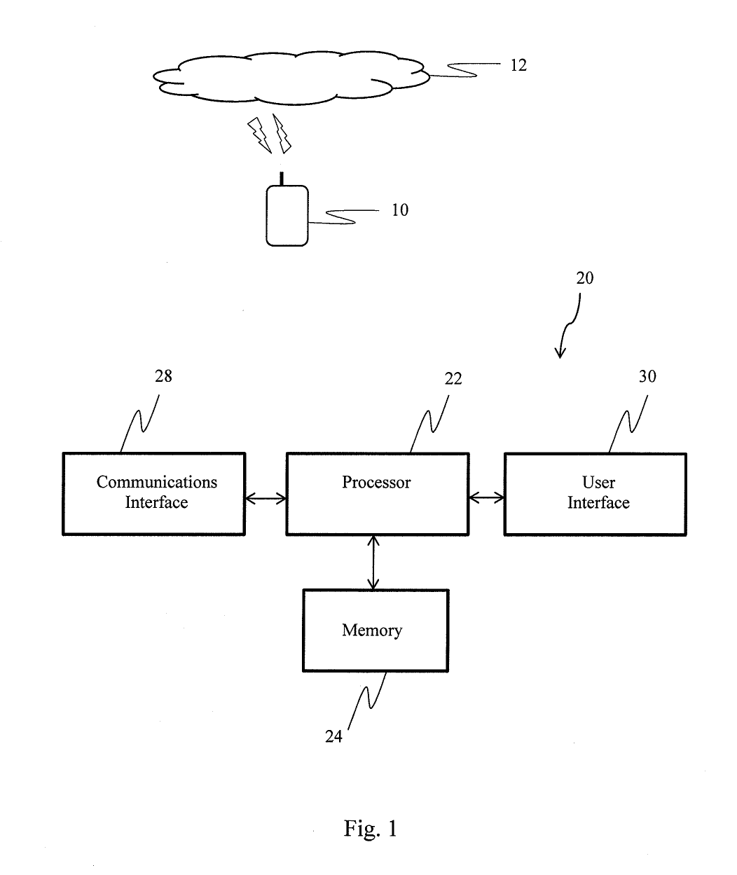

Referring now to FIG. 1, an apparatus 20 that may be embodied by or otherwise associated with a mobile terminal 10 (such as a cell phone, Personal Digital Assistant, notebook, tablet, iPhone, iPad, Android, or other computing device) may include or otherwise be in communication with a processor 22, a memory device 24, a communication interface 28, and a user interface 30.

In some example embodiments, the processor 22 (and/or co-processors or any other processing circuitry assisting or otherwise associated with the processor) may be in communication with the memory device 24 via a bus for passing information among components of the apparatus 20. The memory device 24 may include, for example, one or more non-transitory volatile and/or non-volatile memories. In other words, for example, the memory device 24 may be an electronic storage device (e.g., a computer readable storage medium) comprising gates configured to store data (e.g., bits) that may be retrievable by a machine (e.g., a computing device like the processor). The memory device 24 may be configured to store information, data, content, applications, instructions, or the like for enabling the apparatus to carry out various functions in accordance with an example embodiment of the present invention. For example, the memory device could be configured to buffer input data for processing by the processor. Additionally or alternatively, the memory device 24 could be configured to store instructions for execution by the processor 22.

The apparatus 20 may, in some embodiments, be embodied by a mobile terminal 10. However, in some embodiments, the apparatus may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processor 22 may be embodied in a number of different ways. For example, the processor may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining and/or multithreading. In the embodiment in which the apparatus 20 is embodied as a mobile terminal 10, the processor may be embodied by the processor of the mobile terminal.

In an example embodiment, the processor 22 may be configured to execute instructions stored in the memory device 24 or otherwise accessible to the processor. Alternatively or additionally, the processor may be configured to execute hard coded functionality. As such, whether configured by hardware or software methods, or by a combination thereof, the processor may represent an entity (e.g., physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (e.g., a mobile terminal 10) configured to employ an embodiment of the present invention by further configuration of the processor by instructions for performing the algorithms and/or operations described herein. The processor may include, among other things, a clock, an arithmetic logic unit (ALU) and logic gates configured to support operation of the processor.

Meanwhile, the communication interface 28 may be any means such as a device or circuitry embodied in either hardware or a combination of hardware and software that is configured to receive and/or transmit data from/to a wireless network 12 and/or any other device or module in communication with the apparatus 20. In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In order to support multiple active connections simultaneously, such as in conjunction with a digital super directional array (DSDA) device, the communications interface of one embodiment may include a plurality of cellular radios, such as a plurality of radio front ends and a plurality of base band chains. In some environments, the communication interface may alternatively or also support wired communication. As such, for example, the communication interface may include a communication modem and/or other hardware/software for supporting communication via cable, digital subscriber line (DSL), universal serial bus (USB) or other mechanisms.

In some example embodiments, such as instances in which the apparatus 20 is embodied by a mobile terminal 10, the apparatus may include a user interface 30 that may, in turn, be in communication with the processor 22 to receive an indication of a user input and/or to cause provision of an audible, visual, mechanical or other output to the user. As such, the user interface may include, for example, a keyboard, a mouse, a joystick, a display, a touch screen(s), touch areas, soft keys, a microphone, a speaker, or other input/output mechanisms. Alternatively or additionally, the processor may comprise user interface circuitry configured to control at least some functions of one or more user interface elements such as, for example, a speaker, ringer, microphone, display, and/or the like. The processor and/or user interface circuitry comprising the processor may be configured to control one or more functions of one or more user interface elements through computer program instructions (e.g., software and/or firmware) stored on a memory accessible to the processor (e.g., memory device and/or the like).

In the apparatus embodied by a mobile terminal 10, the processor 22 is the means for executing various functions that may be specified for preparing the mobile terminal for network communications. The memory device 24 may contain program code instructions causing the processor to execute the various functions, or the processor may have memory associated with it that contains the program code instructions. Thus, the means for executing various functions in the mobile terminal may include the memory with computer code instructions stored therein. The communications interface 28 is the means for receiving signals from a network entity that are then processed to determine appropriate functions to be executed by the processor.

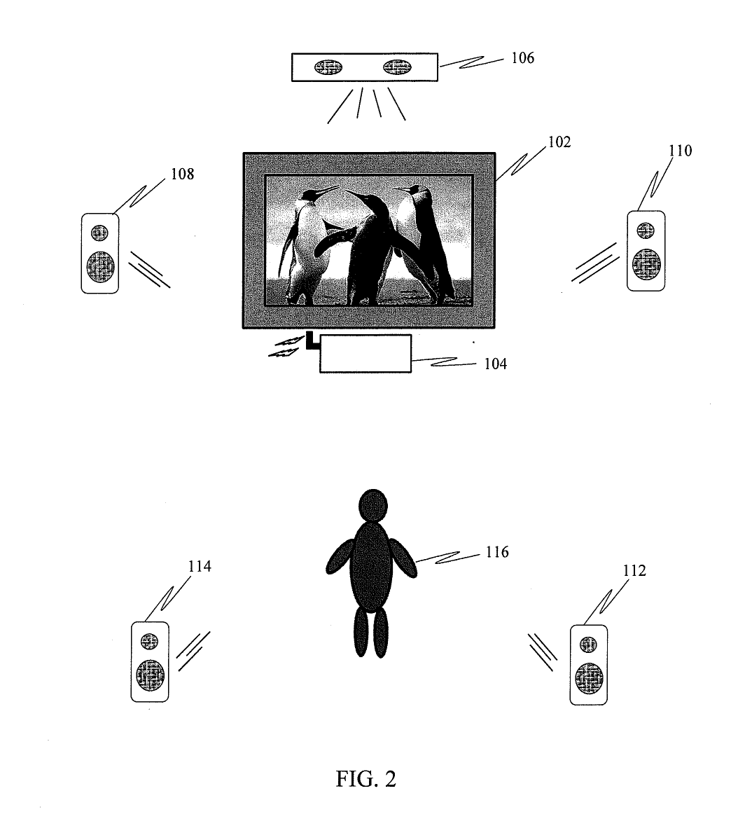

Another wireless apparatus that may be operable with the assistance of a wireless mobile device 20 (such as a cell phone or other mobile computing device) is a stereo surround sound system such as is illustrated in FIG. 2. These systems are generally used for home theater and high performance music reproduction purposes. Wireless speakers may also embody the apparatus 20 or at least components thereof, such as a processor 22, memory 24 and communications interface 28, and in the case of a mobile speaker device a user interface 30.

The basic components of a surround sound system are an amplifier/controller 104 and five or more audio speakers. Each of the speakers produces sound from separate “channels” in the recording being played through the system. Most surround sound systems generally employ a center channel speaker 106 placed close to the screen 102 for viewing movies and television programs. By way of example, two speakers are commonly located to the front left 108 and right 110 of the listener/viewer 116. Two surround speakers are normally placed slightly behind and to the left 114 and right 112 of the listener/viewer 116. This array of speakers, when used properly, gives the sensory impression of being “surrounded” by the sound produced in the theater/music system source amplifier 104. More speakers are employed in systems having more than 5 channels. The description herein is based on a five-speaker system but other embodiments of the invention are adaptable to systems having more channels and speakers. Also, the amplifier/controller 104 and screen 102, although shown separately in FIG. 2 for illustration purposes, may be assembled in a single unit with the amplifier/controller disposed within the screen enclosure.

The original surround sound systems required wiring to be connected from the amplifier/controller to each of the speakers. Wired from a panel on the rear of the controller, each wire was connected to a terminal dedicated to the channel of the speaker being connected. The rear panel connector labeled “front right,” for example, would be wired to the front right speaker. Each of the other speakers had a separate connector to which its wire was connected. One drawback was that all those wires either were visible running throughout the room or they had to be hidden in the walls, ceiling or floor.

Once connected, each speaker to its proper channel, the system could be “tuned” to adjust the relative volume of each speaker to produce the best fidelity and balanced sound to the listener. Like all sound systems, the major variables for performance are the position of the listener relative to the speakers and the acoustics of the room in which the system is located.

One solution to the wiring difficulty is a wireless speaker system. Rather than send the audio signal to the speakers over wired connections, the controller broadcasts the audio over a radio link (typically carrying frequency modulated (FM) channels). The wiring problem disappears. However, a new issue arises in a wireless surround sound system. Each audio channel—where there are at least five as in FIG. 2—is different. Each carries a separate part of the audio of a movie or music recording. In a wireless system, the amplifier/controller broadcasts all five (in this case) audio channels. In order for the system to perform correctly, each wireless speaker must “select” from the multiple radio signals the proper channel for it to receive and convert to sound. Generally, this was handled manually at system setup.

In an embodiment of the present invention, the amplifier controller 104 has a WiFi link capability and each of the wireless speakers also has wireless communications link capability, e.g. a WiFi link capability. The speakers are set out into their proper array for reproducing (in this case) 5.1 surround sound. Other multi-channel standard configurations exist, such as 7.1 surround sound and the invention is not limited to the example of 5.1 surround systems. In order to dynamically allocate the audio channel selections to each speaker, the amplifier/controller 104 and each speaker in an example embodiment contains an apparatus such as that illustrated in FIG. 1 having at least a processor 22, memory 24, and a communications interface 28.

The memory 24 in the amplifier/controller 104 and each speaker 106, 108, 110, 112, 114 stores a locator and channel allocation algorithm. In one embodiment, the locator may be a GPS location process whereby the precise location of the speaker may be determined relative to the amplifier/controller 104. The amplifier/controller 104, also having a locator, saves its own location in memory. As each speaker establishes a wireless (e.g. WiFi) connection to the amplifier/controller, the processor 22 in the speaker causes its location to be sent to the controller. In this example embodiment, once all of the speakers have revealed their respective locations to the controller, the controller performs a location calculation and sends out the channel allocations to the speaker communication interfaces 28 and to their processors 22. The processor in each of the speakers, executing the algorithm stored in memory 24, responds by selecting the audio channel(s) allocated to it.

Because not all speaker environments are ideal in size or layout, in another example embodiment it is possible that one or more speakers may be located in a place where two or more sound channels overlap. The algorithm in the amplifier/controller that assigns the channels to the speakers recognizes that condition and may send more than one channel allocation to the processor 22 in the speaker located in an overlapping sound position. That speaker, through its processor, may select more than one channel and reproduce sound from the more than one channel in an overlapping condition.

In another example embodiment, the communications connection need not be limited to WiFi, but may also be made over a mobile telephony connection such as a long term evolution (LTE) network. A cell phone may establish a mobile wireless communication connection to the controller 104. And the position information for the mobile speaker device may originate from sources other than GPS, such as an accelerometer, a WiFi/LTE system, or any other location system that may function as a “position sensor.”

The “reference” positions in the example audio system are that of the amplifier/controller 104 and the listener 116. Once the reference positions are taken and stored in the controller 104 algorithm processor memory, as the “wireless speaker device” moves, the position sensor of a wireless speaker device informs the controller 104 of the new speaker position and the controller calculates the change in position. The controller algorithm calculates the position in relation to the references, controller position and listener position. Each wireless speaker device is then allocated its correct channel over the communication interface 28 in it based on position.

In another embodiment, the system may have more dynamic allocation capability in that it may allocate shared channels where a mobile wireless speaker's position falls within the audio area that overlaps areas assigned to two different speakers. A speaker, by its processor 24 and communications interface 28, may select more than one channel of sound to reproduce if it is located in an overlap location. This capability is useful, for instance, if the size or shape of the listening space does not permit adequately spaced separate speaker locations.

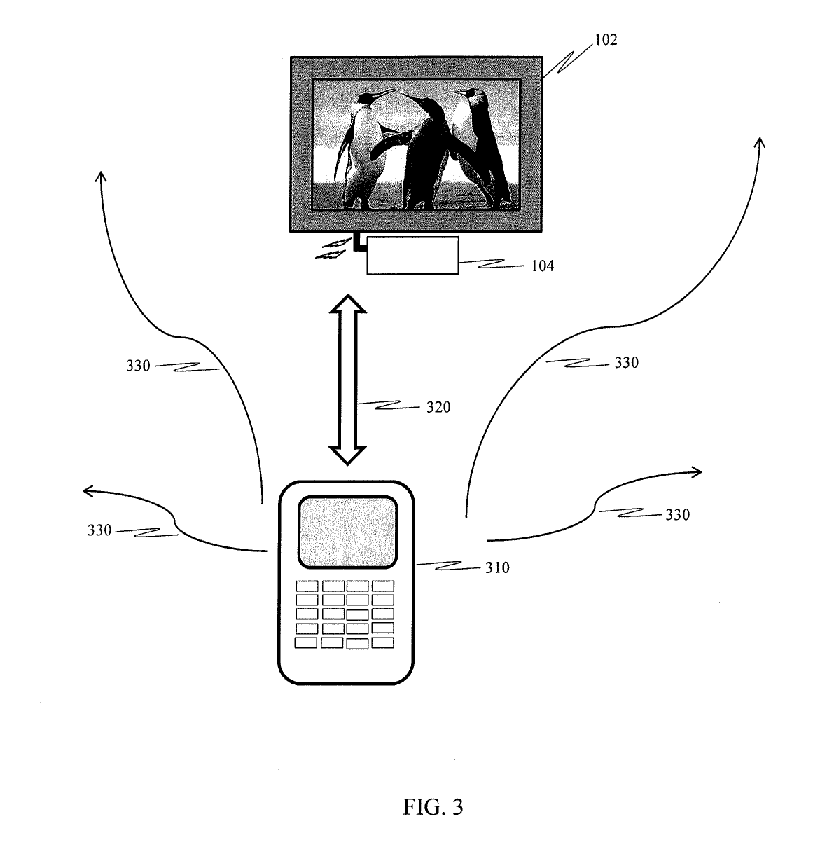

The system is not limited to locating wireless audio speakers. Referring to FIG. 3, in another example embodiment, mobile terminals, such as cell phones, notebooks, tablets or other computing devices with communications capability may be adapted for use in surround systems. Using the example of a cell phone 310, it could establish a connection with the amplifier/controller 104 over a mobile wireless interface 320 such as LTE. Adapted to run the location algorithm, the cell phone 310 could be moved to positions around the listening space of the surround system, as indicated 330 in FIG. 3, its location being tracked and transmitted by the processor 24 and communications interface 28 in the cell phone to the controller 104.

The controller algorithm may allocate channel audio to the cell phone 310 based upon its position, just as it would a speaker. This capability can be useful if there is more than one viewer and each can be allocated separate channels through their computing devices. It can also be adapted for use where there are multiple viewers/players of complex audio/visual programming such as computer games. Each player may receive separate audio channels through individual wireless mobile speaker devices, by their processors 24 and communications interfaces 28, while playing through different computing device interfaces. Each computing device may have an associated headset so that each user may listen to her channel.

An application scenario example embodiment is a user in front of a television (TV) having surround sound with a Wi-Fi interface. The user has a cellphone with Wi-Fi interface and running the algorithm, stored in its memory 24 and executed by its processor 22, to acquire its location, send it to the amplifier/controller through its communications interface 28, and select an audio channel when one or more channels are allocated to it. The user sets in the memory 24 in his cell-phone a position where he will be sitting to watch TV. As he moves his cell phone around himself, the processor 24 running the location algorithm calculates the position variation and selects the audio channel or channels to be received. The communication between the amplifier/controller and the cell phone to determine the audio channel selected and to transport the audio media selected is over the Wi-Fi wireless interface through the communications interface 28 of the wireless mobile speaker device. The amplifier/controller employs a location algorithm to allocate audio channel selections to the external wireless device based on its location.

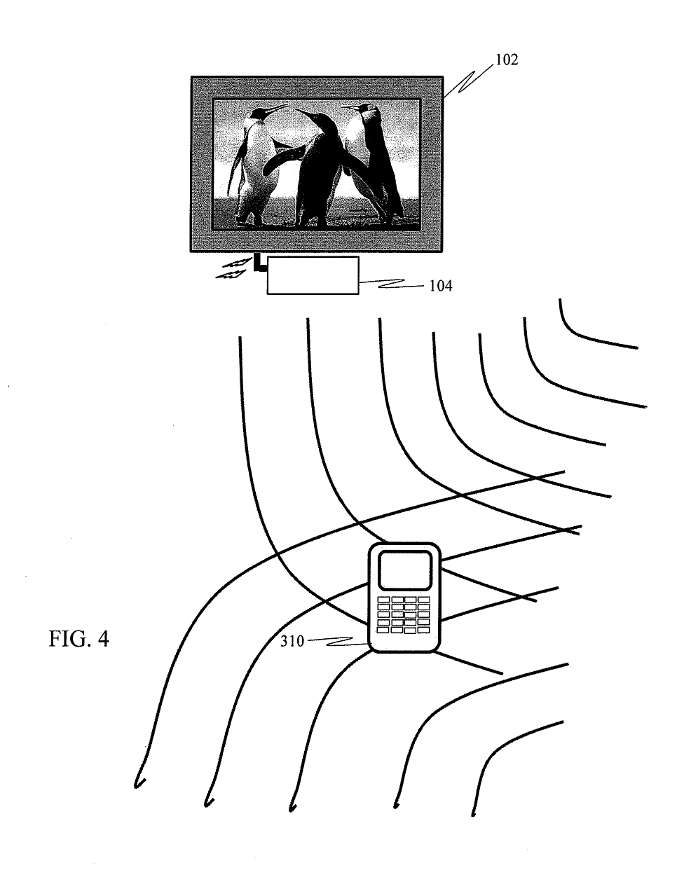

In a further example embodiment, the wireless device 310 may also be allocated more than one channel of sound when located in an overlap position. Referring to FIG. 4, the overlap condition is illustrated for a mobile device 310. The mobile device 310 is located in a position that would be served by two channels (from the upper right and lower right). The same condition may apply to surround system speakers that may not have sufficient space to disperse to widely separated positions. The algorithm in the controller 104 may detect that the position of the wireless device 310 or speaker is in an overlap area. The controller 104 may allocate more than one channel to that device/speaker such that the proper balance of sound can be reproduced regardless of the limitations on the location of the device/speaker.

In another embodiment, an embodiment of the invention may be used to create special auditory effects based on movement of the wireless speaker device. Assuming that on the broadcast side of a live performance or sporting event microphones for sound pickup are located in strategic points, movement of the mobile speaker device can access largely focused sounds. For example, in a symphony orchestra presentation a user can choose to hear a particular instrument or instrument section just by positioning the cellular device in the instrument direction on the screen. Or if the user is watching a soccer game, she can hear the sound near the soccer goalkeeper when a goal occurs just by positioning the cellular device in the goalkeeper direction. As the mobile wireless speaker device is moved about the listener's reference point, the selected audio channel(s) may change based on the wireless speaker device location. This can have the effect of choosing the audio channel that carries the sound of interest more prominently than the other channels. That permits close focus on particularized sounds in the performance.

The following abbreviations may appear in this Description and may also be found in one or more of the claims that follow:

Wi-Fi—Wireless Fidelity

FM—Frequency Modulation

GPS—Global Position System

LTE—long term Evolution

GSM—Global System Mobile

UMTS—Universal Mobile Terrestrial System

TV—Television

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method comprising:
establishing a wireless communications link in a mobile speaker device;
causing transmission of location information of the mobile speaker device;
receiving an audio channel allocation; and
selecting the allocated audio channel in the mobile speaker device.

2. The method of claim 1, further comprising:
determining a location of the mobile speaker device.

3. The method of claim 2, further comprising:
locating the mobile wireless speaker device within an operating area of a wireless multiple channel audio signal.

4. The method of claim 1 wherein the wireless communications link is one of a WiFi or mobile telephone network connection.

5. The method of claim 1 wherein the location information is determined by one of a global positioning system transceiver, a mobile telephone location system, and a WiFi location system.

6. The method of claim 1 wherein the channel allocation comprises a plurality of overlapping channels.

7. The method of claim 1 wherein the mobile speaker device is an audio system speaker.

8. The method of claim 1 wherein the mobile speaker device is a mobile telephone device.

9. An apparatus comprising:
at least a processor, a memory, and computer instructions stored in memory which, when executed by the processor, cause the apparatus to:
establish a wireless communications link in a mobile speaker device;
cause transmission of location information of the mobile speaker device;
receive an audio channel allocation; and
select the allocated audio channel in the mobile speaker device.

10. The apparatus of claim 9 further comprising:
computer instructions in memory which, when executed by the processor, cause the apparatus to:
determine a location of the mobile speaker device.

11. The apparatus of claim 9 wherein the wireless communications link is one of a WiFi or mobile telephone network connection.

12. The apparatus of claim 9 wherein the location information is determined by a global positioning system transceiver.

13. The apparatus of claim 9 wherein the channel allocation comprises a plurality of overlapping channels.

14. The apparatus of claim 9 wherein the mobile speaker device is an audio system speaker.

15. The apparatus of claim 9 wherein the mobile speaker device is a mobile telephone device.

16. A computer program product comprising computer program instructions stored in a non-transitory computer readable medium, said instructions when executed with a processor cause an apparatus to perform:
establishing a wireless communications link in a mobile speaker device;
causing transmission of location information of the mobile speaker device;
receiving an audio channel allocation; and
selecting the allocated audio channel in the mobile speaker device.

17. The computer program product of claim 16, further comprising instructions that, when executed with a processor, cause an apparatus to perform:
determining a location of the mobile speaker device.

18. The computer program product of claim 16, wherein the channel allocation comprises a plurality of overlapping channels.

19. The computer program product of claim 16 wherein the wireless communications link is one of a WiFi or mobile telephone network connection.

20. An apparatus comprising:
a means for establishing a wireless communications link in a mobile speaker device;
a means for causing transmission of location information of the mobile speaker device;
a means for receiving an audio channel allocation; and
a means for selecting the allocated audio channel in the mobile speaker device.
